(19) United States
(12) Patent Application Publication
(10) Pub. No.: US 2022/0271266 A1
(43) Pub. Date: Aug. 25, 2022

(54) METHODS FOR IMPROVING LITHIUM CELL PERFORMANCE COMPRISING CARBON NANOTUBE (CNT)-METAL COMPOSITES

(71) Applicant: TORTECH NANO FIBERS LTD, Ma'alot Tarshiha (IL)

(72) Inventors: Meir Hefetz, Mitzpe Harashim (IL); Arieh Meitav, Rishon Le-Cion (IL); Ivan Surzhyk, Netanya (IL); Eli Rosh Hodesh, Rishon Le-Cion (IL); Yulia Vestfrid, Tel-Aviv (IL); Mor Albert, Petach-Tikva (IL); Stanislav Kozachkevitch, Kibutz Dan (IL); Victor Halperin, Haifa (IL); Sahar Tenenbaum, Shadmot Devora (IL)

(21) Appl. No.: 17/736,296

(22) Filed: May 4, 2022

Related U.S. Application Data
(63) Continuation of application No. PCT/IL2020/051160, filed on Nov. 9, 2020.
(60) Provisional application No. 62/935,656, filed on Nov. 15, 2019.

(51) Int. Cl. H01M 4/04; H01M 4/134; H01M 4/38; H01M 4/66; H01M 10/0525

(52) U.S. Cl. CPC H01M 4/0404; H01M 4/134; H01M 4/382; H01M 4/663; H01M 10/0525; H01M 2004/027

(57) ABSTRACT

The present invention provides methods for forming apparatus and devices including an anode including at least one metallic lithium layer and at least one backing layer, at least one cathode/counter electrode, at least one separator disposed between the anode and the at least one cathode/counter electrode and an electrolyte, wherein the apparatus is configured to provide a lithium utilization efficiency of at least 80% and wherein the at least one backing layer weighs less than 30% of a copper backing layer of the same dimensions.

### FIELD OF THE INVENTION

The present invention relates generally to carbon nanotube-metal composite products and methods of production thereof, and more specifically to methods and apparatus for improving lithium metal battery performance.

### BACKGROUND OF THE INVENTION

Many designs of power apparatus are inefficient, both with respect to the weight of the electrodes, and with respect to the energy provision per unit weight. Safety-related hazards are another important issue with lithium batteries in general and specifically with batteries comprising metallic lithium.

An effort has been made to improve the design of power sources, such as batteries, capacitors and fuel cells. However, many commercially available systems remain inefficient.

Primary lithium batteries comprise metallic lithium anodes. There are two key design versions of primary lithium: (a) bobbin cells and (b) jelly rolled cells.

The bobbin cells are used for low rates, while the jelly rolled for mid to high rates.

There are several commercial chemistries of primary lithium batteries among which are: Li/SO₂, Li/SOCl₂, Li/SO₂Cl₂, Li/MnO₂, Li/FeS₂, Li/CFₓ and others.

Discharge reactions of Lithium/Manganese Oxide system is outlined herein:
System: Li/MnO₂
Overall reaction: Li+Mn⁽⁺⁴⁾O₂→LiMn⁽⁺³⁾O₂
Anode: Li−e⁻→Li⁽⁺¹⁾
Cathode: Mn⁽⁺⁴⁾O₂+e⁻→Mn⁽⁺³⁾O₂

While discharging, the lithium anode undergoes oxidation, meaning conversion of metal to ionic species in the solution. Since the theoretical capacity of lithium metal is 2,080 mAh/c.c. discharging a lithium cell with corresponding capacity of 0.2 mAh/cm² results in a thickness reduction of the lithium anode by 1 μm (per each 0.2 mAh/cm²).

Table A herein presents the electrode design of two commercial Li/MnO₂ CR123A cells of 1,500 mAh.

| | Cell | | | | Nom. Capacity |
|---|---|---|---|---|---|
| Manufacturer | type | Size (mm) | Weight (g) | Voltage (V) | mAh |
| H | CR125A | ϕ17 × 34.5 | 20 | 3.0 | 1,500 |
| P | CR125A | ϕ17 × 34.5 | 17 | 3.0 | 1,550 |

TABLE B
Comparison of different prior art cells

| Cell design\Manufacturer | | H | P |
|---|---|---|---|
| Nominal Cell Capacity | | 1,500 | 1,550 |
| Cathode | MnO₂ | | |
| Length | mm | 230 | 230 |
| Width | mm | 25 | 25 |
| Total Thickness | μm | 430 | 440 |
| Current Collector | | Al mesh | S.S. mesh |
| AM | mAh/g | 230 | 240 |
| AL | mg/cm² | 125 | 120 |
| AM (@ 90% AM) | mAh/cm² | 26 | 26 |
| Anode | Li metal | | |
| Length | mm | 230 | 230 |
| Width | mm | 24 | 24 |
| Total Thickness | μm | 180 | 180 |
| Current Collector | Direct tabbing | No | No |
| AM | mAh/g (theoretical) | 3,860 | 3,860 |
| AM | mg/cm² | 9.7 | 9.7 |
| AM | mAh/cm² | 37.5 | 37.5 |
| Capacity Anode/Cathode | | 1.44 | 1.44 |

It can be seen that the anode capacity is in excess of cathode capacity by about 45%. The reason is related to the fact that during discharge the lithium gets thinner and thinner and since practically the actual current density along the electrodes is not even, the lithium may get disconnected from the end terminal tabbing, or from some other anode areas being discharged at higher current density due to uneven compression of the stack/jelly roll. Aside capacity loss, the lithium irregularity with partial disconnection along the electrode may result at occasional sparking causing the cell to catch fire with accompanying safety hazards.

There therefore remains an unmet need for improved lithium batteries. There further remains a need for safe production processes for manufacturing improved lithium batteries.

### SUMMARY OF THE INVENTION

The present invention provides methods for forming apparatus and devices including an anode including at least one lithium layer and at least one backing layer, at least one cathode, at least one separator disposed between the anode and the at least one cathode and an electrolyte, wherein the apparatus is configured to provide a lithium utilization efficiency of at least 80% and wherein the at least one backing layer weighs less than 30% of a copper backing layer of the same dimensions.

It is an object of the present invention to provide improved performance and safety of lithium batteries comprising metallic lithium anode via implementation of carbon nanotube (CNT)-metal composite substrates.

In some further embodiments of the present invention, improved products comprising CNT-metal composite substrates are provided.

In some further embodiments of the present invention, reduced-weight products comprising CNT-metal composite substrates are provided.

In some additional embodiments of the present invention, improved products comprising CNT-metal composite substrates for current collection and physical unity are provided.

In some further additional embodiments of the present invention, improved products are provided comprising a composite material of light-weight, conductive, thin substrate with a relatively high tensile strength.

In some additional embodiments of the present invention, reduced-weight products comprising CNT-metal composite substrates for current collection are provided.

In some additional embodiments of the present invention, improved methods for producing products comprising CNT-metal composite substrates are provided.

In some additional embodiments of the present invention, improved methods for producing products comprising CNT metal composite substrates for current collection are provided.

It is an object of some aspects of the present invention to provide methods and apparatus with efficient current collection.

In some embodiments of the present invention, improved methods and apparatus are provided for reduced-weight, efficient current collection.

In other embodiments of the present invention, a method and system is described for providing high-efficiency current collection.

In additional embodiments for the present invention, a method and apparatus is provided for low-weight, high-efficiency current collection.

In additional embodiments for the present invention, a method and apparatus is provided for low-weight, high-efficiency current collection.

### EMBODIMENTS

1. An apparatus comprising:
a. an anode comprising:
   i. at least one metallic lithium layer;
   ii. at least one backing layer;
b. at least one of a counter-electrode and a cathode;
c. at least one separator disposed between said anode and said at least one of said counter-electrode and said cathode; and
d. an electrolyte;
wherein said apparatus is configured to provide a lithium utilization efficiency of at least 80% and wherein said at least one backing layer weighs less than 30% of a copper backing layer of the same dimensions.

2. An apparatus according to embodiment 1, wherein said at least one backing layer comprises a carbon nanotube (CNT)-based layer.

3. An apparatus according to embodiment 2, wherein said at least one metallic lithium layer comprises two metallic lithium layers on each side of said CNT-based layer.

4. An apparatus according to embodiment 3, wherein said carbon nanotube (CNT)-based layer is of a thickness in the range of 1-50 microns.

5. An apparatus according to embodiment 4, wherein said at least one metallic lithium layer is of a thickness in the range of 10-500 microns.

6. An apparatus according to embodiment 5, wherein said apparatus comprises two metallic lithium layers, each of a thickness in the range of 10-500 microns and further comprises said carbon nanotube (CNT)-based layer of a thickness in the range of 1-50 microns therebetween.

7. An apparatus according to embodiment 6, wherein said at least one of a counter-electrode and a cathode comprises two counter-electrodes or two cathodes.

8. An apparatus according to embodiment 1, wherein said at least one separators comprise polypropylene.

9. An apparatus according to embodiment 1, wherein said electrolyte comprises typical electrolyte used in Li-Ion cells, such as EC:DMC(1:1).

10. An apparatus according to embodiment 1, wherein said metallic lithium utilization efficiency is at least 88%.

11. An apparatus according to embodiment 3, wherein two metallic lithium layers are each of a thickness in the range of 10-500 microns and further comprises said carbon nanotube (CNT)-based layer of a thickness in the range of 1-50 microns therebetween.

12. An apparatus according to embodiment 11, wherein said two metallic lithium layers are each of a thickness in the range of 25-35 microns and further wherein said apparatus comprises said carbon nanotube (CNT)-based layer of a thickness in the range of 2-10 microns therebetween.

13. An apparatus according to embodiment 12, wherein said lithium utilization efficiency is in the range of 89-98%.

14. A method for forming an apparatus, the method comprising:
a. forming an anode comprising:
   i. at least one metallic lithium layer; and
   ii. at least one backing layer;
b. separating said anode from at least one of a counter-electrode and a cathode by disposing at least one separator between said anode and said at least one of a counter-electrode and a cathode; and
c. providing an electrolyte; thereby providing said apparatus to provide a lithium utilization efficiency of at least 80% and wherein said at least one backing layer weighs less than 30% of a copper backing layer of the same dimensions.

15. A method according to embodiment 14, wherein said at least one backing layer a carbon nanotube (CNT)-based layer.

16. A method according to embodiment 14, wherein said at least one metallic lithium layer comprises two metallic lithium layers on each side of said CNT-based layer.

17. A method according to embodiment 16, wherein said carbon nanotube (CNT)-based layer is of a thickness in the range of 1-50 microns.

18. A method according to embodiment 17, wherein said at least one metallic lithium layer is of a thickness in the range of 10-500 microns.

19. A method according to embodiment 18, wherein said apparatus comprises two lithium layers, each of a thickness in the range of 10-500 microns and further comprises said carbon nanotube (CNT)-based layer of a thickness in the range of 1-50 microns therebetween.

20. A method according to embodiment 19, wherein said at least one of a counter-electrode or cathode comprises two counter-electrodes or cathodes.

21. A method according to embodiment 20, wherein said at least one separator comprises two separators disposed between said two counter-electrodes or two cathodes and said anode.

22. A method according to embodiment 21, wherein said two separators comprise polypropylene.

23. A method according to embodiment 15, wherein said electrolyte comprises EC:DMC(1:1).

24. A method according to embodiment 23, wherein said lithium utilization efficiency is at least 88%.

25. A method according to embodiment 24, wherein two metallic lithium layers, are each of a thickness in the range of 10-500 microns and further comprises said carbon nanotube (CNT)-based layer of a thickness in the range of 1-50 microns therebetween.

26. A method according to embodiment 25, wherein two metallic lithium layers are each of a thickness in the range of 25-35 microns and further comprises said carbon nanotube (CNT)-based layer of a thickness in the range of 2-4 microns therebetween.

27. A method according to embodiment 26, wherein said lithium utilization efficiency is in the range of 89-96% +/−4%.

28. An apparatus according to embodiment 1, wherein said at least one backing layer weighs less than 25, 20 or 15% of a copper backing layer of the same dimensions.

29. A method according to embodiment 14, wherein said at least one backing layer weighs less than 25, 20 or 15% of a copper backing layer of the same dimensions

Further, according to an embodiment of the present invention, the at least one carbon nanotube (CNT) mat includes two carbon nanotube (CNT) mats.

Additionally, according to an embodiment of the present invention, the apparatus further includes an active material coated/applied on the at least one CNT mat.

Moreover, according to an embodiment of the present invention, the apparatus is a power source selected from a battery, a capacitor and a fuel cell.

Further, according to an embodiment of the present invention, the cathode/counter electrode current collector includes at least one of aluminum, gold, platinum, copper and combinations thereof.

Additionally, according to an embodiment of the present invention the Li-metal binding/application step to the substrate backing includes methods such as, but not limited to, physical methods, chemical methods, gluing, electrical methods, non-electrical methods.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified diagram of a method for forming a lithium-copper anode (Li-Cu-Li).

FIG. 1B is a simplified diagram of a method for forming a lithium-CNT-backed anode (Li-CNT-Li), in accordance with an embodiment of the present invention;

FIG. 1C is a simplified diagram of a method for forming a lithium reference anode, in accordance with an embodiment of the present invention;

FIG. 1D shows different options for central and end tabbing of a lithium layer, in accordance with an embodiment of the present invention;

FIG. 2A is a simplified diagram of a method for forming an apparatus comprising a lithium-copper anode (Li-Cu-Li) of FIG. 1A and two graphite counter-electrodes, in accordance with an embodiment of the present invention;

FIG. 2B is a simplified diagram of a method for forming an apparatus comprising a lithium-CNT-backed anode (Li-CNT-Li) of FIG. 1B and two graphite counter-electrodes, in accordance with an embodiment of the present invention;

FIG. 2C is a is a simplified diagram of a method for forming an apparatus comprising a lithium reference anode of FIG. 1C and two graphite counter-electrodes, in accordance with an embodiment of the present invention;

FIG. 3A is an experimental Voltage-Capacity chart of four cells of the apparatus of FIG. 2A with a lithium-Cu-backed anode of FIG. 1A, in accordance with an embodiment of the present invention;

FIG. 3B is an experimental Voltage-Capacity chart of five cells of FIG. 2B with a lithium-CNT-backed anode of FIG. 1B, in accordance with an embodiment of the present invention;

FIG. 3C is an experimental Voltage-Capacity chart of five cells of the apparatus of FIG. 2C with a lithium reference anode of FIG. 1C, in accordance with an embodiment of the present invention;

FIG. 4 is a plot of the delivered capacity of a Li-Cu-Li apparatus of FIG. 2A, a Li/CNT/Li apparatus of FIG. 2B and a reference Li apparatus of FIG. 2C, in accordance with some embodiments of the present invention;

FIG. 5A is a simplified flow chart of a method for forming a Li-CNT-Li pouch cell, in accordance with some embodiments of the present invention;

FIG. 5B is a simplified flow chart of a method for forming a Li-Cu-Li pouch cell, in accordance with some embodiments of the present invention; and

FIG. 5C is a simplified flow chart of a method for forming a Cu foil-Li-Cu foil reference pouch cell, in accordance with some embodiments of the present invention.

FIG. 6A is a photograph of a copper substrate (after discharge of the cell, such as Li-Cu-Li apparatus of FIG. 2A and FIG. 3A), clean of any Li residuals, in accordance with some embodiments of the present invention;

FIG. 6B is a photograph of a CNT substrate (after discharge of the cell, such as a Li-CNT-Li apparatus of FIG. 2B, 3B), clean of any Li residuals, in accordance with some embodiments of the present invention; and

FIG. 6C is a photograph of a Li anode (after discharge of the cell of a Li-CNT-Li apparatus, FIG. 2C, FIG. 3C), comparing the original width of Li anode with its final width as photographed, in accordance with some embodiments of the present invention.

In all the figures similar reference numerals identify similar parts.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

### Definitions

Lithium utilization efficiency means herein:—a value in percent of the delivered capacity of a cell divided by the theoretical calculated maximum multiplied by 100.

The present invention provides methods for forming apparatus and devices including an anode including at least one lithium layer and at least one backing layer, at least one of a counter-electrode and a cathode, at least one separator disposed between the anode and the at least one counter-electrode/cathode and an electrolyte, wherein the apparatus is configured to provide a lithium utilization efficiency of at least 80% and wherein the at least one backing layer weighs less than 30% of a copper backing layer of the same dimensions.

In some further embodiments of the present invention, improved products comprising CNT-based substrates are provided.

In some further embodiments of the present invention, reduced-weight products comprising CNT-based substrates are provided.

In some additional embodiments of the present invention, improved methods for producing products comprising CNT-based substrates are provided.

According to some embodiments, the invention includes a Lithium primary and/or rechargeable lithium-ion battery (LIB or LB) although no limitation is intended and it can be applicable to other battery/electrode types or any of the devices referred to above. A typical metallic-Lithium cell comprises a lithium negative (anode) and usually a sulfur-based or oxide positive (cathode). The negative electrode (anode) consists of metallic lithium. The positive electrode (cathode) consists usually of sulfur-based or oxide active material supported on an aluminum current collector.

By active material is meant a material deposited on a current collector which provides chemical energy.

For an anode, the active material may be lithium. The cathode active material may be sulfur-based or oxide.

The negative and positive electrodes are wrapped with separator material, wound or layered into a jelly roll or stack and inserted for example into cylindrical, prismatic or pouch type containers. Usually the electrodes are tabbed to provide external contacts, electrolyte is added to the cell, the cell is then sealed and electrochemical formation is performed..

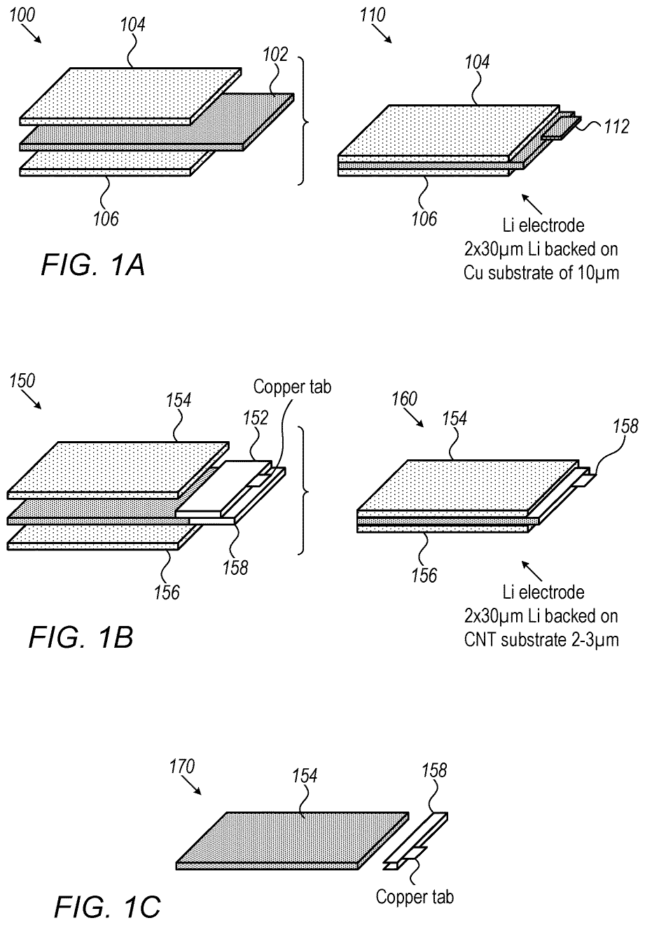

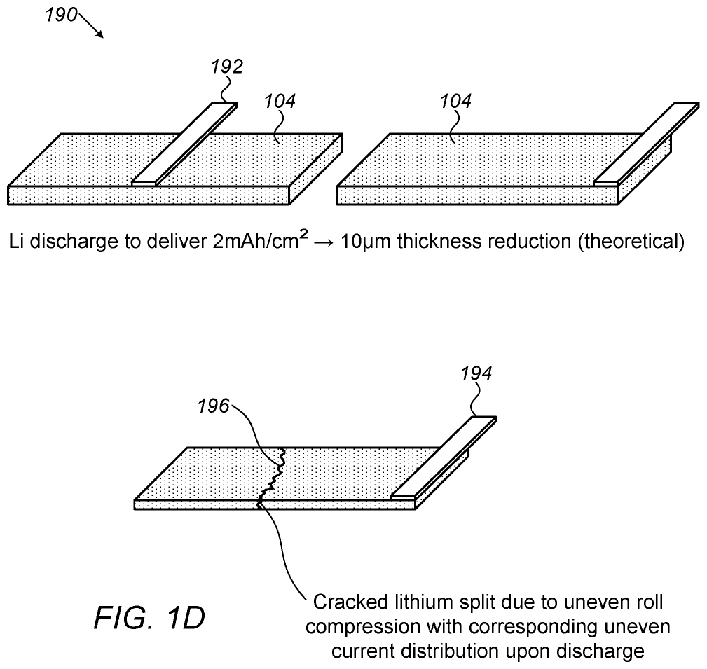

Reference is now made to FIG. 1A, which is a simplified diagram of a method 100 for forming a lithium-copper anode 110, in accordance with an embodiment of the present invention. Anode 110 comprises a copper (Cu) layer 102 cut to shape to form a backing layer and a copper tab 112 and generally rectangular conducting copper layer. The copper layer is combined with two peripheral lithium (Li) layers 104 and 106 to form a Li-Cu-Li sandwich anode 110, by methods known in the art.

FIG. 1B is a simplified diagram of a method 150 for forming a lithium-CNT-backed anode 160, in accordance with an embodiment of the present invention.

Anode 160 comprises a carbon nanotube layer (CNT) layer 152 cut to shape and tabbed with a copper tab 158 and generally rectangular CNT layer. The CNT layer is combined with two peripheral lithium (Li) layers 154 and 156 to form a Li-CNT-Li sandwich anode 160, by methods known in the art.

FIG. 1C is a simplified diagram of a method for forming a lithium reference anode 170, in accordance with an embodiment of the present invention.

The lithium reference anode 170 may or may not comprise on or more copper foil layers and typically comprises a copper tab 158. The lithium reference anode is combined with peripheral two separators 202,204 and two counter-electrodes or cathodes 230, each typically comprising an active cathode material 210 and an aluminum current collector 220.

FIG. 1D shows different options 190 for central tabbing of a lithium layer 104 with a central copper tab 192. Another option is using the lithium layer 104 with an end tab 194 to perform end tabbing To avoid the described capacity loss and safety hazards, the lithium may be rolled on top of thin copper foil as illustrated in FIG. 1A.The copper ensures mechanical integrity of the lithium foil. However the copper backing contributes considerable extra weight, thereby reducing the specific energy of the cell.

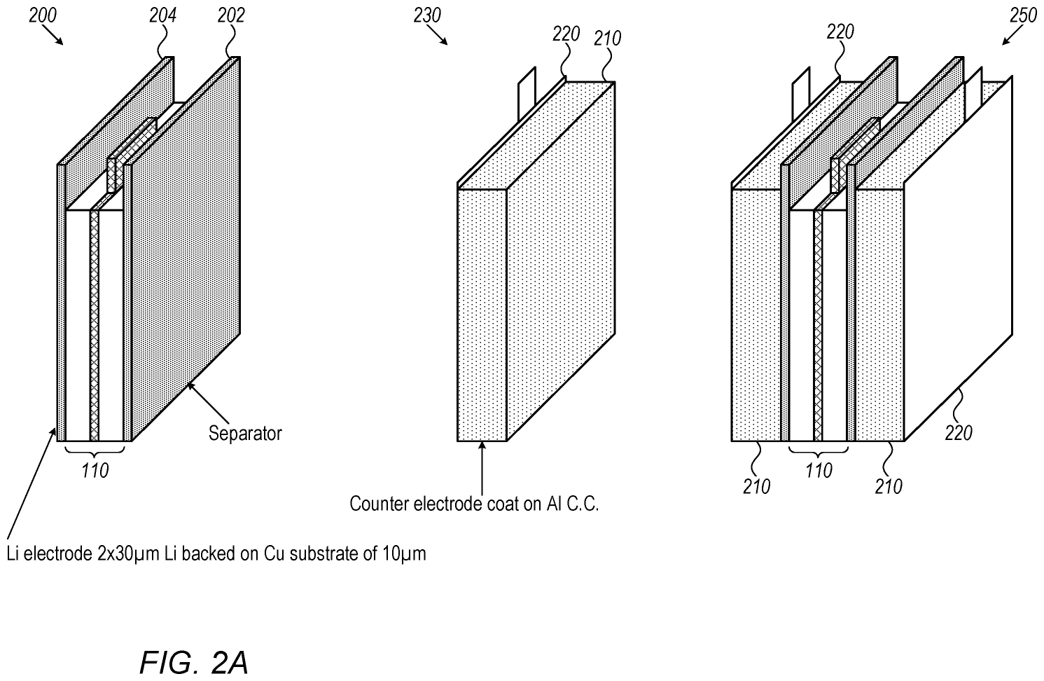

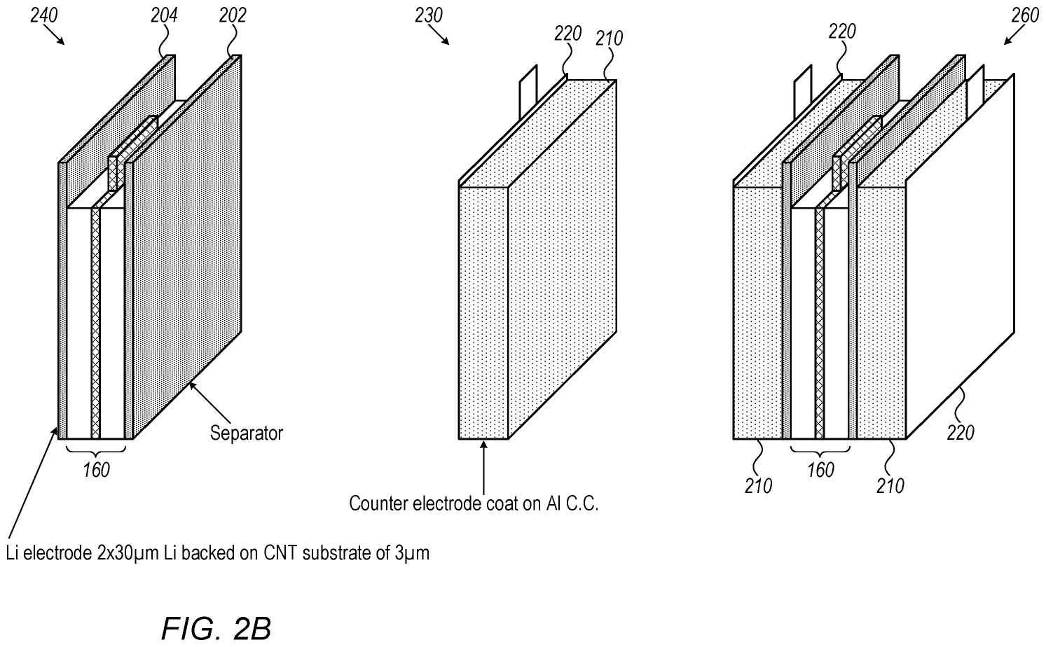

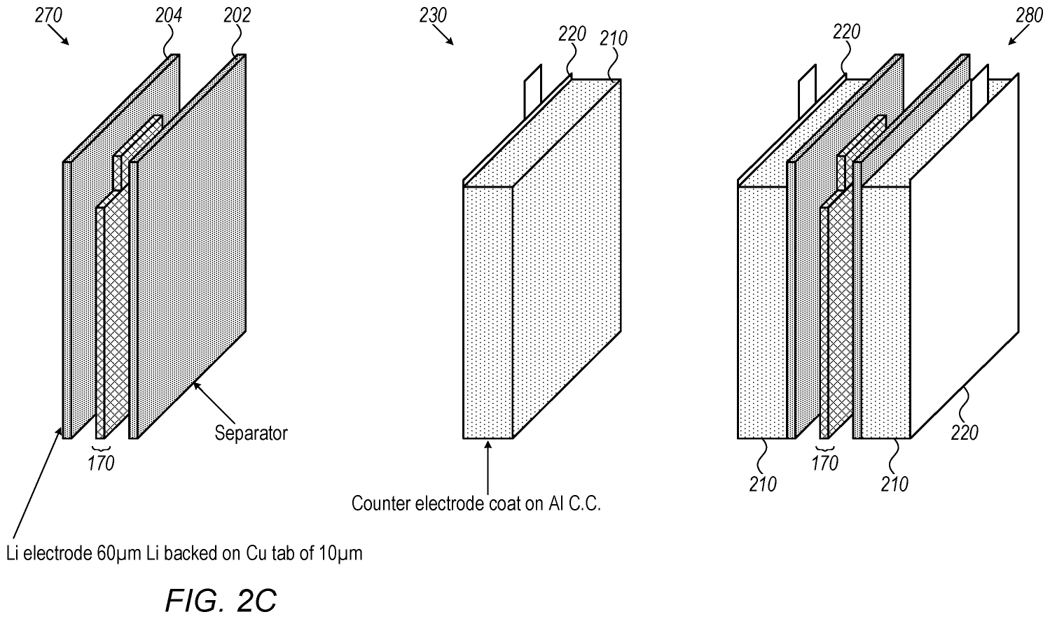

FIG. 2A is a is a simplified diagram of a method 200 for forming an apparatus 250 comprising the Li-Cu-Li sandwich anode 110 of FIG. 1A and two counter-electrodes 230, 230, in accordance with an embodiment of the present invention. Two separators 202 are bonded/pressed onto the sandwich anode. Thereafter, two counter electrodes 230, each comprising a layer of active material layer or coat 210 on an aluminum current collector 220 are added on the other side of the separator, from the anode.

FIG. 2B is a is a simplified diagram of a method for forming an apparatus 260 comprising a Li-CNT-Li sandwich anode 160 of FIG. 1B and two counter-electrodes 230, 230 in accordance with an embodiment of the present invention. Two separators 202 are bonded/pressed onto the Li-CNT-Li sandwich anode. Thereafter, two counter electrodes 230, each comprising a layer of active cathode material or coat 210 on an aluminum current collector 220 are added on the other side of the separator, from the anode.

FIG. 2C is a is a simplified diagram of a method for forming a reference apparatus 270 comprising a lithium reference anode 170 of FIG. 1C and two counter-electrodes 230, 230, in accordance with an embodiment of the present invention.

Two separators 202 are bonded/pressed onto a lithium reference anode 170. Thereafter, two counter electrodes 230, each comprising a layer of active cathode material or coat 210 on an aluminum current collector 220 are added on the other side of the separator, from the anode.

In actual cells, the counter electrode to Lithium is cathode on Al C.C.

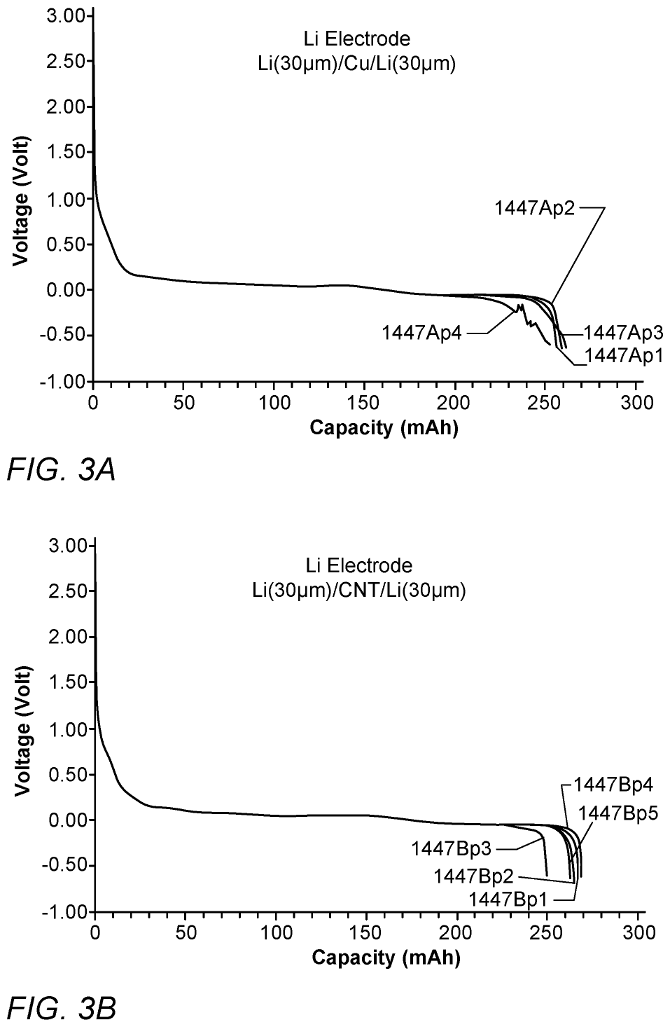

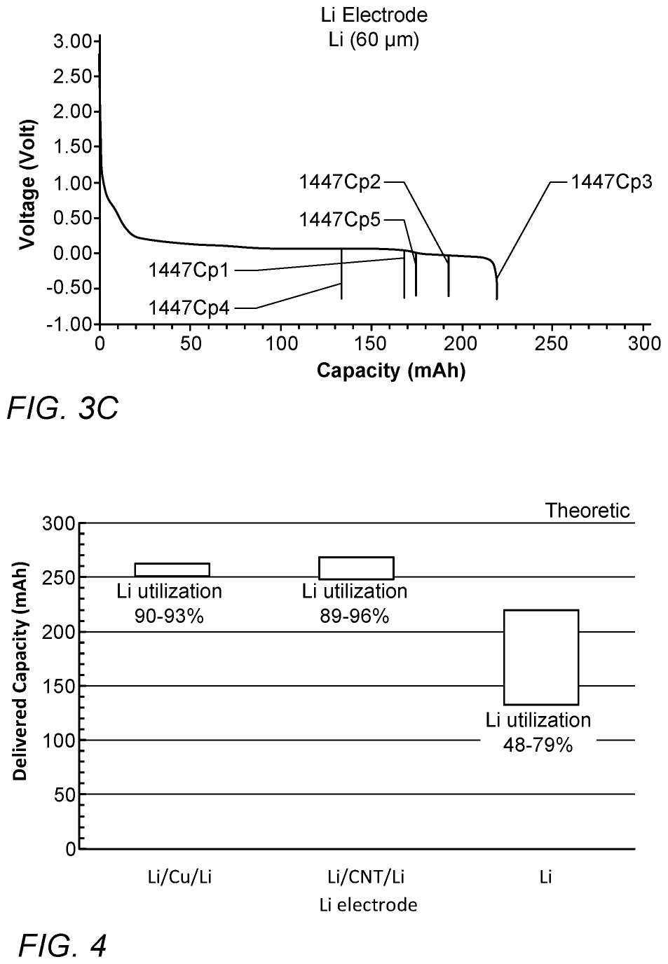

In our specific experiment to prove the concept of the invention we used graphite counter electrode. FIGS. 3A-C and FIG. 4 present the results of our experimental cell.

### EXAMPLE

Three (3) groups of cells were constructed: Group A with Lithium anode backed from both sides of Copper foil—FIG. 3A; Group B with Lithium anode backed from both sides of CNT mat—FIG. 3B; Group C with Lithium anode w/o any backing—FIG. 3C; The counter electrode in all groups was graphite electrode with extra capacity over the capacity of the lithium electrode to ensure maximal lithium discharge/consumption within the design parameters, thereby stressing the current invention.

FIG. 3A is an experimental chart of capacity against voltage with a Li-Cu-Li sandwich anode 110 of FIG. 1A, in accordance with an embodiment of the present invention.

This graph shows the results of four experiments with apparatus 250 (+electrolyte and housed in a pouch). Galvanostatic polarization at a current of 5 mA was performed to the cells 250 reaching a voltage of −0.5V (running into over-discharge; starting oxidation of electrolyte) and continuously recording the accumulated capacity. The capacity range that was withdrawn from the Li/Cu/Li cell was from around 250-260 mAh, resulting in a Li utilization of around 90-93% (FIG. 4).

FIG. 3B is an experimental chart of capacity against voltage with a Li-CNT-Li sandwich anode 160 of FIG. 1B, in accordance with an embodiment of the present invention. This graph shows the results of five experiments with apparatus 260 (+electrolyte and housed in a pouch). Galvanostatic polarization at a current of 5 mA was performed to the cell reaching a voltage of −0.5V (running into over-discharge;

starting oxidation of electrolyte) and continuously recording the accumulated capacity. The capacity range that was withdrawn from the Li/CNT/Li cell was from around 250-270 mAh, resulting in a Li utilization of around 89-96% (FIG. 4).

FIG. 3C is an experimental chart of capacity against voltage with a lithium reference anode 170 of FIG. 1C, in accordance with an embodiment of the present invention. Five discharge experiments were performed as follows with apparatus 270 (+electrolyte and housed in a pouch). Galvanostatic polarization at a current of 5 mA was performed to the cell reaching a voltage of −0.5V (running into over-discharge; starting oxidation of electrolyte) and continuously recording the accumulated capacity. The capacity range that was withdrawn from the reference cell was from around 130-220 mAh, resulting in a Li utilization of around 48-79% (FIG. 4).

As can be seen from FIG. 3C, the spread and standard deviation of the accumulated capacities were far greater in the reference cell 270, than those seen in the Li/CNT/Li cell results of FIG. 3B and of the LI/Cu/Li cell 250 results in FIG. 3A. This means practically that one can obtain a much better use/utilization of lithium in cells 250 with anode 110 and cell 260 with anode 160, relative to the reference cell. This provides both economic and environmental advantages to the cells of the present invention over the prior art. Furthermore, there is a smaller requirement for excess lithium in the cells of the present invention, relative to the prior art cells. This saving may be from 12-100%, or from 12-30% or 12-50% of the total lithium excess.

FIG. 4 is a graph of the delivered capacity of a Li-Cu-Li apparatus 250 of FIG. 2A, a Li/CNT/Li apparatus 260 of FIG. 2B and a reference Li apparatus 270 of FIG. 2C, in accordance with some embodiments of the present invention. For the purposes of the present invention:—

### Lithium Utilization Efficiency

A theoretical maximal capacity of lithium is 3,830 mAh/g=2,070 nAh/c.c. The practical utilization depends on many factors. Lithium utilization is measured in cells with capacity of counter electrode exceed that of the lithium.

Thus, lithium utilization =delivered capacity/theoretical capacity;

and lithium utilization efficiency percent=delivered capacity/theoretical capacity×100.

Using a CNT or copper substrate or backbone increases the safe use of the cell by minimizing short circuits, sparks, and lithium disintegration. It should be noted, however, that the CNT substrate provides the significant weight advantage to the cell (being much lighter) per the examples in table 2. While with pristine Lithium anode, extra 30-100% of lithium is required to ensure physical integrity of the lithium, with copper or CNT backing the extra capacity is avoided. So in respect to electrode thickness the copper or CNT backing enables reducing anode thickness thereby enabling to wind/jelly roll longer electrodes with correspondingly increased capacity. However, while copper can provide clear benefit in respect to thickness/volume gain copper use as the lithium backing results at considerable weight rise bearing negative impact on the specific energy.

Implementing CNT mat as the backing substrate of Lithium provides same mechanical integration backing like copper, however with minimal effect on weight. Also, since the CNT mat is embossed into the soft lithium it hold minimal effect on thickness.

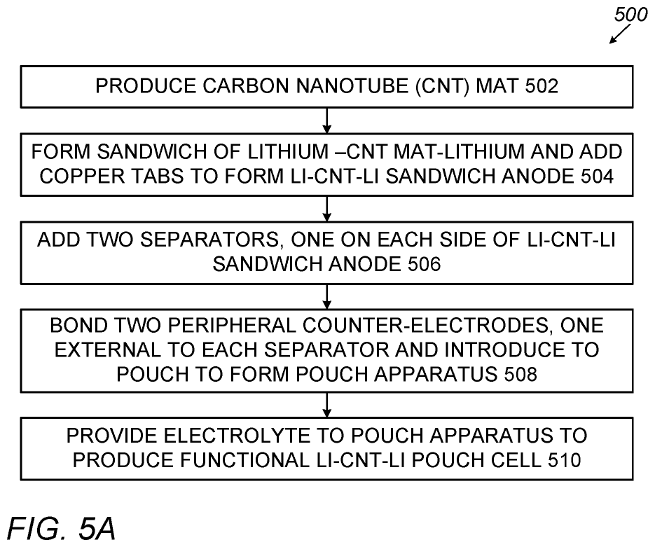

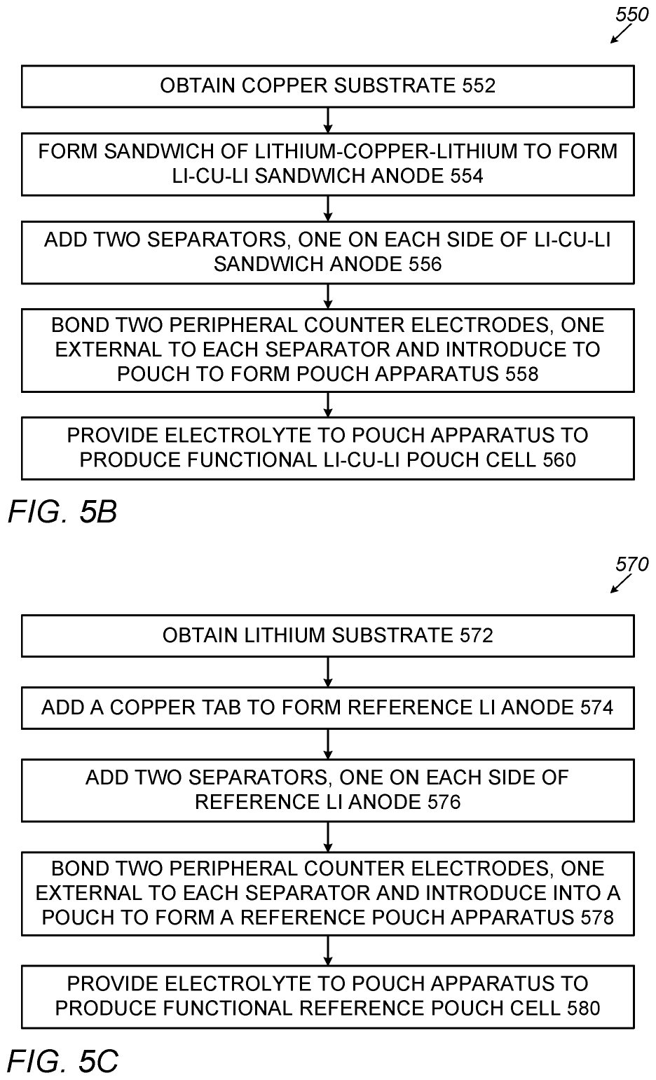

Reference is now made to FIG. 5A, which is a simplified flow chart of a method 500 for forming a Li-CNT-Li pouch cell 260 (FIG. 2B), in accordance with some embodiments of the present invention.

In a producing a carbon-nanotube (CNT) mat or mats step 502, several gaseous components are injected into a reactor. The reactor is inside a furnace in a temperature range of 900-1600 Celsius. The gaseous components include a carbon source, which is gaseous under the above conditions, such as, but not limited to, a gas, such as methane, ethane, propane, butane, saturated and unsaturated hydrocarbons and combinations thereof. Another gaseous component is a catalyst or catalyst precursor, such as, ferrocene. A carrier gas is typically used, such as, helium, hydrogen, nitrogen and combinations thereof. In some cases, this process is defined as a floating catalyst CVD (chemical vapor deposition) process.

Without being bound to any particular theory, the catalyst reduces the activation energy in extracting carbon atoms from the gas and carbon nanotubes start to nucleate on top of the catalyst, which may be in the form of nano-particles. Further into the tubular reactor, the CNT are elongated and this continues, until a critical mass is formed in the form of an aero-gel-like substance, which exits in the reactor. The aero-gel-like substance is collected on a rotating drum, which moves from side to side. The speed of rotation of the rotating drum and other process conditions and duration determine the final thickness and properties of the carbon-nanotube mat. A typical range of thickness of the CNT mat is 10-150 microns.

In a forming an anode step 504, a sandwich of lithium-CNT mat-lithium is formed, per FIG. 1B and add copper tabs 158 to form LI-CNT-LI sandwich anode 160.

Thereafter, two separators 202 are added, one on each side of LI-CNT-LI sandwich anode, in an isolating anode step 506.

In a forming pouch step, first two peripheral counter-electrodes 230 (FIG. 2B) are added, each one external to each separator to form a sandwich LI-CNT-LI cell 265. Thereafter the sandwich cell is introduced into a pouch 267.

In a providing electrolyte step 510, an electrolyte 268 is added in the pouch to produce a functional LI-CNT-LI pouch cell 269.

Reference is now made to FIG. 5B, which is a simplified flow chart 550 of a method for forming a Li-Cu-Li pouch cell, in accordance with some embodiments of the present invention.

In an obtaining a copper substrate step 552, a copper substrate may be purchased or manufactured, per FIG. 1A. in a forming a sandwich anode step 552, two lithium layers are bonded to the copper substrate to form a Li-Cu-Li sandwich anode 110 (FIG. 1A).

Thereafter, two separators 202 are added separators, one on each side of LI-Cu-LI sandwich anode, in an isolating anode step 556.

In a forming pouch step 558, first two peripheral counter-electrodes 230 (FIG. 2A) are added, each one external to each separator to form a sandwich LI-Cu-LI cell 250. Thereafter the sandwich cell is introduced into a pouch 257.

In a providing electrolyte step 560, an electrolyte 258 is added in the pouch to produce a functional Li-Cu-Li pouch cell 259.

Reference is now made to FIG. 5C, which is a simplified flow chart of a method 570 for forming a Li reference pouch cell 579, in accordance with some embodiments of the present invention.

In an obtaining a lithium substrate 170 step 572, a lithium substrate may be manufactured or purchased.

Thereafter, one or more copper tabs 172 may be added in a tabbing step 574 to complete the manufacture of the reference Li anode (170, FIG. 1C).

Thereafter, two separators 202 are added, one on each side of the reference anode, in an isolating anode step 576.

In a forming reference pouch apparatus step 578, two peripheral counter-electrodes 230 (FIG. 2C) are added, each one external to each separator to form reference apparatus 270 (FIG. 2C). Thereafter the reference apparatus is introduced into a pouch 267.

In a providing electrolyte step 580, an electrolyte 268 is added in the pouch to produce a functional reference Li pouch cell 299.

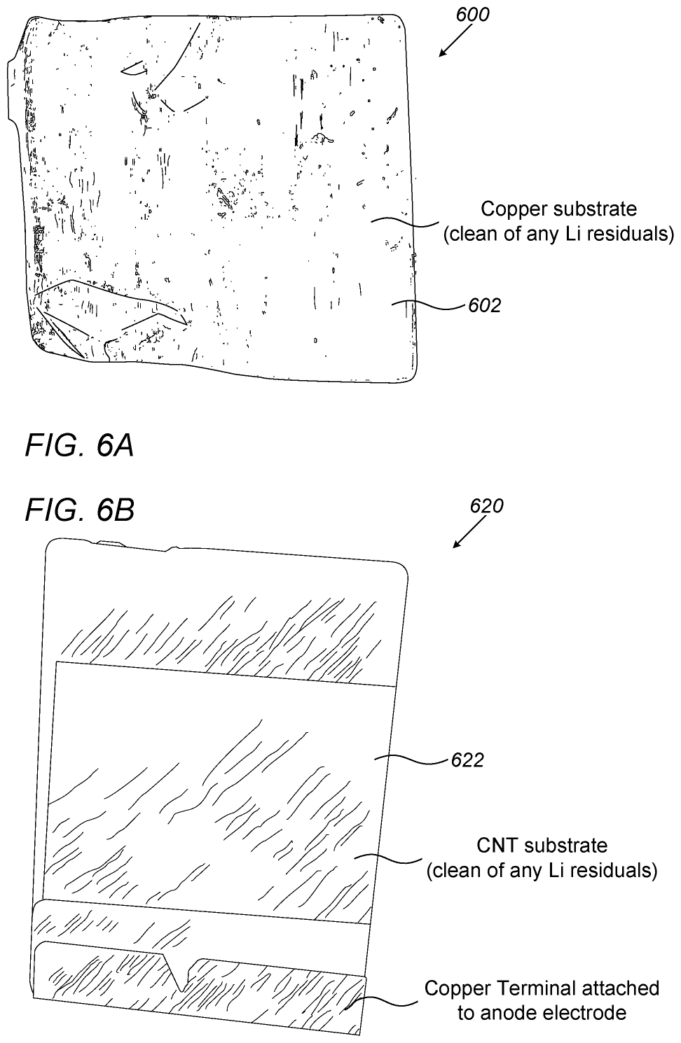

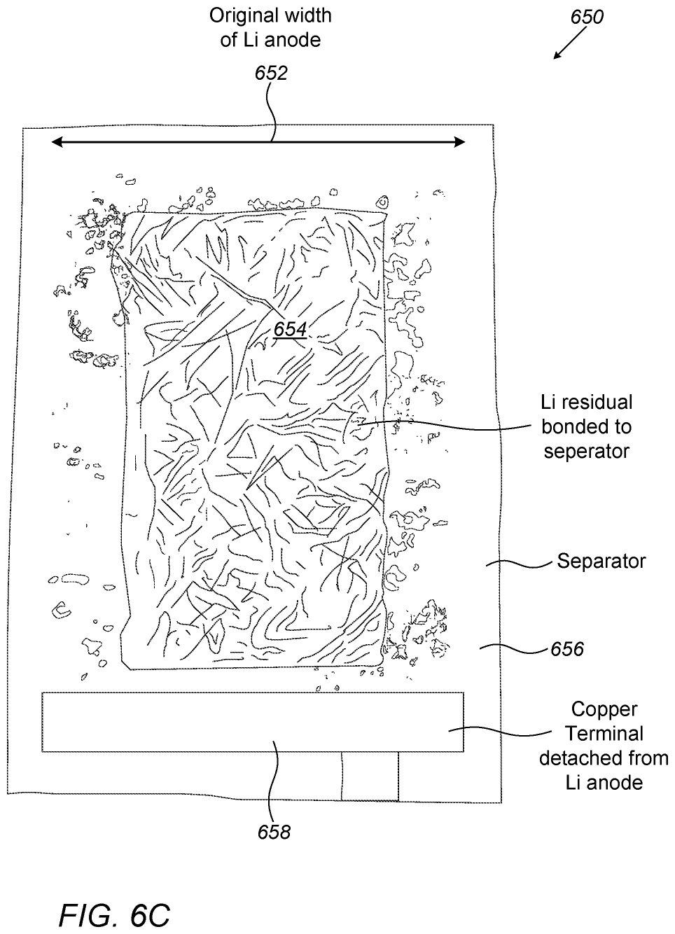

FIG. 6A is a photograph 600 of a copper substrate 602 (after use in a cell, such as Li-Cu-Li apparatus of FIG. 2A), clean of any Li residuals, in accordance with some embodiments of the present invention.

FIG. 6B is a photograph 620 of a CNT substrate 622 (after use in a cell, such as a Li-CNT-Li apparatus of FIG. 2B) with a copper tab 624, clean of any Li residuals, in accordance with some embodiments of the present invention.

FIG. 6C is a photograph 650 of a Li anode 654, comparing the original width 652 of Li anode with its final width 653 as photographed on a separator 656, in accordance with some embodiments of the present invention.

### EXAMPLE

Saving each 1 μm lithium thickness enables to increase capacity by 0.2 mAh/cm². Thus, referring to cells above, if using copper backing of 6-10 μm the lithium capacity may be balanced to the cathode—26-28 mAh/cm² instead of the 37.5 mAh/cm2 reducing lithium thickness by about 50 μm or overall about 40 micron taking into account the copper thickness. Thus instead of using 180 micron lithium anode, lithium-copper anode of overall 50 micron provide same performance with markedly increased safety.

Table 2 herein illustrates weight comparison of primary Li-metal cell using pristine Li, Li with copper backing and Lithium with CNT backing vs. Referring to specific cylindrical cell comprising an internal jelly roll with dimensions as indicated in the table.

| | | Pristine | Backed Li/X/Li | | |
|---|---|---|---|---|---|
| | | Lithium | X = Copper | | X = CNT |
| Delivered Spec. | mAh/cm² | 26 | | | |
| Capacity | | | | | |
| Cathode Spec. Capacity | mAh/cm² | 26 | | | |
| Anode Spec. capacity | mAh/cm² | 37-40 | 28 | | |
| Li thickness | μm | 185-200 | 140 | | |
| Substrate thickness | μm | 0 | 6 | 10 | 2-3 |
| Overall Anode thickness | μm | 185-200 | 146 | 150 | 143 |
| Li Weight | mg/cm² | 9.7-10.8 | 7.6 | | |
| Substrate Weight | mg/cm² | 0 | 5.3 | 8.9 | 0.35 |
| Overall Anode Weight | mg/cm² | 9.7-10.8 | ~13 | 16.5 | ~8 |
| Cylindrical cell | | ϕ 17 mm/H 32 mm | | | |
| Electrode width | cm | 2.5 | | | |
| Electrode Length | cm | 23 | 26 | 25 | 27 |
| Electrode Area | cm² | 57.5 | 65 | 62.5 | 67.5 |
| Cell Capacity | mAh | 1,495 | 1,690 | 1,625 | 1,755 |
| Cell Weight* | gram | 14.4 | 15.8 | 16.2 | 15.4 |
| Spec. En. (@ 2.8 V Nom.) | Wh/kg | 290 | 300 | 280 | 320 |

| | |
|---|---|
| Extra Spec. Energy | +14% |

+7%

+10%

*Weight - Including all components, excluding case:

Components include
Electrolyte
Cathod +Al C.C.
Separator
Anode:
   a) Pristine Li at 50% extra capacity
   b) Li at 5-7% extra capacity over cathode capacity, on Cu C.C. of 6/10 μm
   c) Composite Li at 5-7% extra capacity over cathode capacity on CNT C.C.

Experiments conducted with Li primaries comprising the three types of Lithium anode (FIG. 4) showed that performance of Li-CNT comprising cells is equivalent to those comprising Li-10 micron copper. Cells comprising pristine lithium of same thickness as the other two groups, w/o excess of lithium, showed marked capacity variance with up to >50% reduced capacity.

It should be understood that these flowcharts and figures are exemplary and should not be deemed limiting. Some of the sequences of the steps may be changed. Some steps may not be performed. Some or all of flowcharts 5A, 5B and 5C may be combined in various combinations and permutations.

According to some embodiments of the present invention, there is provided a device comprising a lithium layer and a CNT layer, the device constructed and configured to deliver capacity of at least 10, 15, 20, 25 or 30 mAh/cm² and have a thickness of less than 95%, 90%, 85%, 80% or 75% of a device constructed without the CNT layer, but of the same capacity.

According to some embodiments of the present invention, there is provided a device comprising a lithium layer and a CNT layer, the device constructed and configured to deliver capacity of at least 10, 15, 20, 25 or 30 mAh/cm² and weigh less than 95%, 90%, 85%, 80% or 75% of a device constructed without the CNT layer, but of the same capacity.

The references (experimental results) cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A method for forming an apparatus, the method comprising:
a. forming an anode comprising:
i. at least one lithium layer of a thickness in the range of 10-500 microns; and
ii. at least one backing layer;
b. separating said anode from at least one of a counter-electrode and a cathode by disposing at least one separator between said anode and said at least one of a counter-electrode and a cathode; and
c. providing an electrolyte;
thereby providing said apparatus to provide a lithium utilization efficiency of at least 80% and wherein said at least one backing layer weighs less than 30% of a copper backing layer of the same dimensions.

2. A method according to claim 1, wherein said at least one backing layer comprises a carbon nanotube (CNT)-based layer.

3. A method according to claim 2, wherein said at least one metallic lithium layer comprises two metallic lithium layers on each side of said CNT-based layer.

4. A method according to claim 3, wherein said carbon nanotube (CNT)-based layer is of a thickness in the range of 1-50 microns.

5. A method according to claim 4, wherein said at least one metallic lithium layer is of a thickness in the range of 25-500 microns.

6. A method according to claim 5, wherein said apparatus comprises two lithium layers, each of a thickness in the range of 25-500 microns and further comprises said carbon nanotube (CNT)-based layer of a thickness in the range of 1-50 microns therebetween.

7. A method according to claim 6, wherein said at least one of a counter-electrode and a cathode comprises two counter-electrodes or two cathodes.
